(19) United States
(12) Patent Application Publication
(10) Pub. No.: US 2015/0260214 A1
(43) Pub. Date: Sep. 17, 2015

(54) WASHER INTENDED FOR USE IN A SCREWED ASSEMBLY AND METHOD OF ASSEMBLY USING THE WASHER

(71) Applicant: THALES, Courbevoie (FR)

(72) Inventors: Alain MISTRAL, CANNES LA BOCCA (FR); Silvain LEGRAND, NICE (FR); Yves ALABREBIS, CAGNES SUR MER (FR)

(21) Appl. No.: 14/657,787

(22) Filed: Mar. 13, 2015

(30) Foreign Application Priority Data
Mar. 14, 2014 (FR) 14 00612

(51) Int. Cl. F16B 29/00; F16B 43/00

(52) U.S. Cl. CPC F16B 29/00; F16B 43/00

(57) ABSTRACT

A washer, intended to be used in a screwed assembly, comprises two opposing faces, the washer being intended to be compressed between its two faces in the assembly. The washer comprises two materials both extending from one face to the other. A first of the two materials has a lower stiffness than a second of the two materials. The stiffnesses of the two materials are defined in such a way as to allow the first material to deform in its elastic domain and the second material to deform in its plastic domain. A method of assembling mechanical components using the washer is also provided.

### CROSS-REFERENCE TO RELATED APPLICATION

This application claims priority to foreign French patent application No. FR 1400612, filed on Mar. 14, 2014, the disclosure of which is incorporated by reference in its entirety.

### FIELD OF THE INVENTION

The invention relates to the field of assemblies performed using screwed connections. This type of assembly is widely used for joining a number of mechanical components together. It uses a number of accessories such as screws, nuts and washers.

### BACKGROUND

The accessories used to join the components together must be sized to avoid any detachment or slipping of the mechanical components relative to one another. More specifically, it is necessary to master the forces applied by the accessories to the mechanical components. These forces need to be high enough to withstand the environmental conditions of the assembly, such as a vibratory environment for example. Very harsh environments are notably encountered in the field of space. When satellites are launched, very intense vibrations occur which can lead to screwed assemblies working loose. After launch, it is impossible to intervene in order to re-tighten these assemblies. It is therefore necessary to have perfect control over the assembly and the method of performing same.

One method currently used is to tighten the screw or the nut to a predefined torque, for example using a torque wrench. This method is not entirely satisfactory because it is unable to guarantee very high forces, notably as a result of significant spread. The problem is that this method measures the tightening force indirectly. It necessitates the use of statistical calculations in order to guarantee that a tightening force is within the predefined tolerance band.

In order to measure the tightening force directly it is possible to interpose a force measurement sensor, such as a strain gauge sensor, for example, in the assembly. This type of solution tends to increase the cost of the assembly, both in terms of the additional elements that have to be added to the assembly and in terms of the time taken to take a measurement and compare it against an expected value.

### SUMMARY OF THE INVENTION

The invention seeks to master the force applied in a screwed assembly in a way that is simple and avoids any recourse to a measurement of force.

One object of the invention is a washer intended to be used in a screwed assembly, the washer comprising two opposing faces, the washer being intended to be compressed between its two faces in the assembly, the washer further comprising a first and a second materials both extending from one face to the other, wherein the first material has a lower stiffness than the second material, wherein the stiffnesses of the two materials are defined in such a way as to allow the first material to deform in its elastic domain and the second material to deform in its plastic domain.

Another object of the invention is a method of assembling mechanical components using a screw and a washer interposed in the assembly, the washer comprising two opposing faces, the washer being intended to be compressed between its two faces in the assembly, the washer further comprising a first and a second materials both extending from one face to the other, the first material having a lower stiffness than the second material, the method consisting in performing assembly by tightening the assembly until the second material undergoes plastic deformation, the first material remaining in its elastic-deformation domain.

The invention can be implemented by means of any screw-nut system in which the washer of the invention is interposed. Use may be made of a screw or of a stud. Tightening can be performed by turning the screw or by turning a nut collaborating with the screw or the stud. A washer according to the invention can be placed directly under the nut, under a head of the screw or even between the various components that are to be assembled.

### BRIEF DESCRIPTION OF THE DRAWINGS

The invention will be better understood and other advantages will become apparent from reading the detailed description of one embodiment given by way of example, which description is illustrated by the attached drawing in which:

FIG. 1 depicts a screwed assembly using a washer according to the invention;

FIGS. 2A and 2B depict the washer according to FIG. 1;

FIG. 3 depicts the load as a function of the elongation of one of the materials of which the washer is made;

FIGS. 4, 5, 6 and 7 depict various alternative forms of a washer according to the invention.

For the sake of clarity, in the various figures the same elements bear the same references.

### DETAILED DESCRIPTION

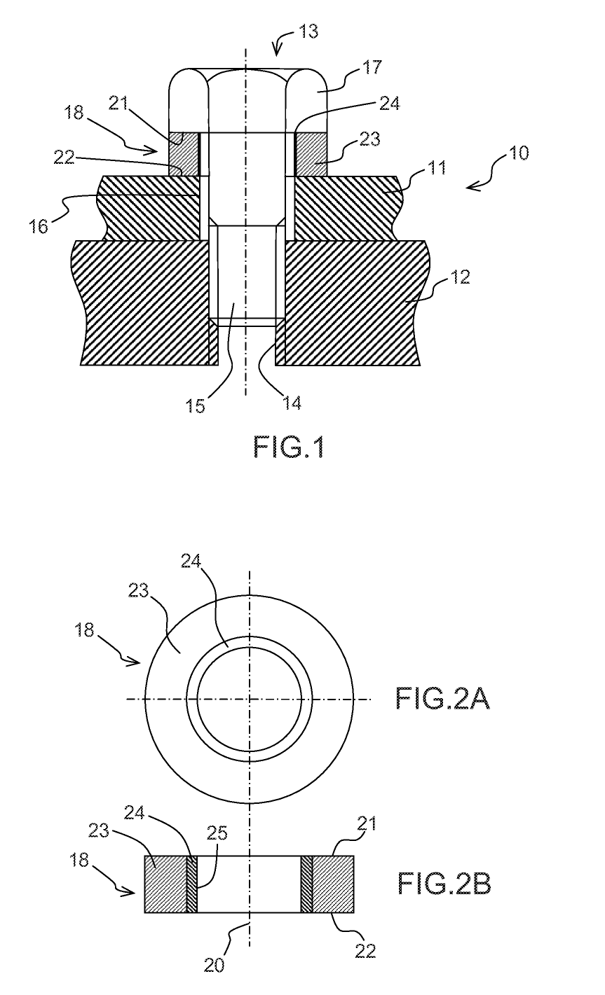

FIG. 1 depicts a screwed assembly 10. Two mechanical components 11 and 12 are held fixed together by means of a screw 13. The component 12 has a tapping 14 collaborating with a threaded part 15 of the screw 13. The component 11 comprises a bore 16 through which the screw can pass freely. The screw 13 comprises a head 17 bearing against the component 11 via a washer 18.

The washer 18 is round and extends about an axis 20. The washer 18 is holed along the axis 20 substantially to the nominal diameter of the screw 13. Once assembly has been performed, the screw 13 passes through the washer 18 and therefore extends along the axis 20.

The washer 18 comprises two opposing faces 21 and 22, both perpendicular to the axis 20. In other words, the two faces 21 and 22 are parallel to one another. At the time of assembly the washer 18 is compressed between its two faces 21 and 22 in the assembly.

According to the invention, the washer 18 comprises two materials both extending between the two faces 21 and 22. The two materials are chosen to have different stiffnesses defined in such a way as to allow the first material to deform in its elastic domain and the second material to deform in its plastic domain. At the time of assembly of the washer 18 the two materials undergo compression parallel to one another.

The head 17 of the screw 18 bears against the two materials present in the washer 18 via the face 21. The two materials of the washer 18 bear against the component 11 via the face 22. The two materials advantageously have a constant cross section parallel to the two faces 21 and 22.

FIGS. 2A and 2B depict in greater detail one alternative form of the washer 18. FIG. 2A depicts the washer 18 in a view from above perpendicular to the axis 20 and FIG. 2B depicts the washer 18 in section on a plane containing the axis 20.

In the alternative form depicted, the washer 18 is formed of two coaxial materials 23 and 24. The washer 18 comprises a cylindrical bore 25 passing through it from one face to the other. The bore 25 runs along the axis 20 and allows the screw 13 to pass through the washer 18. The material 24 extends over the surface of the bore 25. In other words, the material 23 forms the outside of the washer 18 and the material 24 forms the inside of the washer 18 in the region of the bore 25 thereof. At the time of assembly and tightening of the screw 13, the two materials 23 and 24 are compressed in parallel.

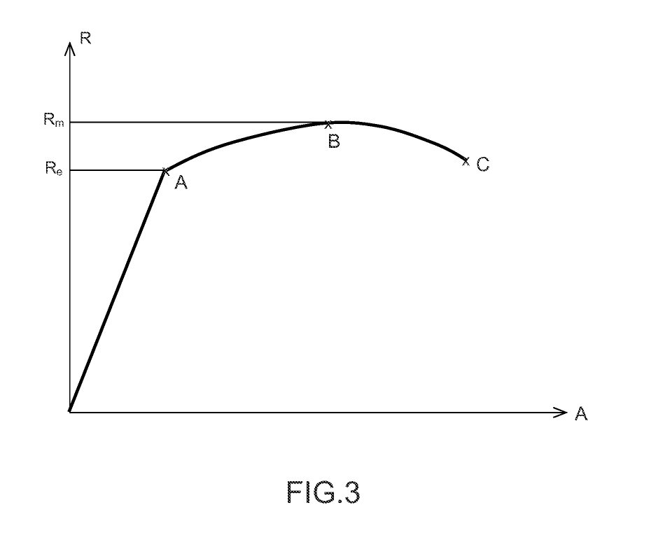

FIG. 3 depicts load as a function of elongation for the material intended to deform in its plastic domain at the time of assembly, in this instance the material 24. The elongation is represented on the abscissa axis and the load on the ordinate axis. At the origin of the frame of reference, the material 24 experiences no stress. The load represents the compressive force per unit area of the material. The elongation represents the deformation of the material per unit length of the material. In the example depicted in FIG. 1, the load is the force applied by the screw 13 as it is tightened divided by the surface area of the material 24 perpendicular to the axis 20. The elongation is the variation in length of the material 24 divided by its initial length along the axis 20. The material 24 is compressed, so the elongation is therefore negative. FIG. 3 depicts the absolute value of the elongation. In practice, numerous materials, such as metallic materials for example, behave symmetrically and oppositely in compression and in tension.

Between the origin of the frame of reference and a point A on the curve shown in FIG. 3, the material 24 undergoes elongation in proportion to the load it experiences. The material 24 is in its elastic domain. The elongation is reversible and when the load is removed, the elongation disappears. The maximum load in the elastic domain is denoted Re and corresponds to the point A. Beyond the elastic domain, as the load increases, the material 24 enters a domain of plastic deformation. The deformation then becomes irreversible and permanent. The permissible load may be increased to a maximum value denoted Rm beyond which the material ruptures. The gradient of the curve depicted in FIG. 3 experiences a sudden drop beyond the point A until it reaches a zero gradient at a point B which corresponds to the maximum load Rm. Beyond that, the gradient of the curve becomes negative as far as a point C at which the material ruptures.

The invention makes use of the break in gradient at the point A between the elastic domain and the plastic domain. As the screw 13 is tightened, in the elastic domain, the tightening force increases linearly with the deformation of the material. By increasing the tightening, on passing from the elastic domain into the plastic domain, the loss of linearity of the deformation can be felt. An operator or a torque measuring sensor can determine this break in gradient. In practice, certain materials at the point A exhibit a region in the curve that has a substantially horizontal break between the elastic domain and the plastic domain where the gradient of the curve goes up again. This break makes it easier to determine the transition between the two, elastic and plastic, domains.

The break in gradient caused by the material 24 becoming “plastic” can be felt by the operator using a conventional spanner or a torque wrench. This break in gradient may be observed by measuring the torque and the angle of tightening. The torque and the angle of tightening may be measured using a manual or automatic torque angle wrench. The use of an automatic torque angle tightening tool makes it possible to get around the problem of spread associated with the operator, the tightening tool stops tightening as soon as a break in gradient of more than a given value in the torque/tightening-angle curve is measured.

Given that the deformation is proportionally greater in the plastic domain than in the elastic domain, a washer according to the invention is particularly well suited to manual or automatic tightening to an angle. The application of a given angle (for example one quarter of a turn) once a given torque has been reached makes it possible to be certain that the material 24 is in the plastic domain and therefore that a minimum tightening force has been applied to the assembly 10.

The two materials 23 and 24 and the respective sizing thereof are chosen as a function of the desired tightening force for the screwed assembly. The value of the desired force corresponds to the force necessary to pass from the elastic domain to the plastic domain in the case of the material 24. For this value, the material 23 remains in its elastic domain so that it does not disrupt determining that the material 24 has passed from the elastic domain to the plastic domain.

In other words, the method of assembly according to the invention involves tightening the assembly until the material 24 reaches plastic deformation, the material 23 remaining within its elastic-deformation domain.

In the alternative form of FIGS. 2A and 2B, as the assembly is tightened the material 24 may buckle and reduce the diameter of the bore 25. When buckling, the material 24 may remain in its elastic domain. The desired function of making it possible to detect the transition from the elastic domain to the plastic domain is no longer fulfilled. In order to alleviate this disadvantage, the two materials 23 and 24 may be fixed together, for example by bonding.

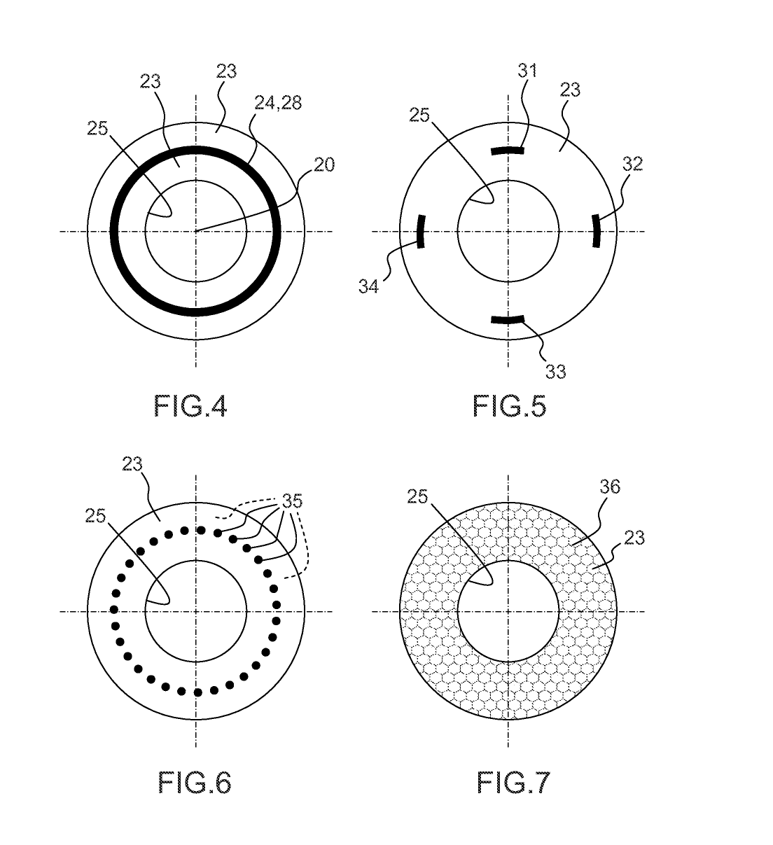

Alternatively, the material 24 may be completely embedded in the material 23. More specifically, the material 24 comprises faces perpendicular to the two faces 21 and 22 of the washer 18. The faces of the material 24 are all embedded in the first material 23. A number of alternative forms of embedded material 24 are depicted in FIGS. 4 to 7 which depict the washer 18 in a view from above perpendicular to the axis 20.

In FIG. 4, the material 24 forms a cylinder 28 extending perpendicular to the two faces 21 and 22 of the washer 18. The cylinder 28 may be concentric with the bore 25.

In FIG. 5, the material 24 comprises several angular segments surrounding the bore 25. In the example of FIG. 5, four segments 31, 32, 33 and 34 are depicted. The angular segments are a constant cross section perpendicular to the axis 20 and extend from the face 21 to the face 22. The angular segments are uniformly distributed around the bore 25.

In FIG. 6, the material 24 comprises several stakes 35, advantageously identical. The stakes 35 have a constant cross section perpendicular to the two faces 21 and 22. The stakes 35 are uniformly distributed around the bore 25.

The uniform distribution of the angular segments 31, 32, 33 and 34 and of the stakes 35 makes it possible to determine a force (transition from the elastic domain to the plastic domain in the case of the material 24) centered on the axis 20. The number of stakes 35 or of angular segments is determined in order to achieve a given force that is dependent on the nature of the material 24, notably on the elastic strength Re thereof and the cross section thereof perpendicular to the axis 20.

In FIG. 7, the material 24 forms a lattice 36 embedded in the material 23. FIG. 7 depicts a honeycomb opening onto the two faces 21 and 22. Other forms of lattice are possible. They advantageously have an open structure so that the material 24 can fill all of the empty spaces of the lattice structure.

In all the alternative forms depicted in FIGS. 2, 4, 5, 6 and 7, the two materials 23 and 24 extend between the two faces 21 and 22 of the washer 18. At the time of assembly and of tightening of the screw 13, the two materials 23 and 24 are compressed in parallel.

The material 24 may be metallic. For example, a titanium-based alloy may be chosen. The material 23 may be moulded around the material 24. The material 23 may be based on polyether ether ketone also known by its abbreviation PEEK. This material has good mechanical properties compatible with a severe environment such as the environment of space. This material notably has an elongation greater than that of titanium thus allowing it to remain in its elastic domain when the titanium of the material 24 reaches its plastic domain.

1. A washer configured for use in a screwed assembly, the washer comprising two opposing faces, the washer being configured to be compressed between its two faces in the assembly, further comprising a first and a second materials both extending from one face to the other, wherein the first material has a lower stiffness than the second material, wherein the stiffnesses of the two materials are defined in such a way as to allow the first material to deform in its elastic domain and the second material to deform in its plastic domain.

2. The washer according to claim 1, wherein the two faces are parallel and wherein the two materials have a constant cross section parallel to the two faces.

3. The washer according to claim 1, further comprising a cylindrical bore passing through the washer from one face to the other and wherein the second material extends over the surface of the bore.

4. The washer according to claim 1, wherein the second material comprises faces perpendicular to the two faces of the washer, and wherein the faces of the second material are all embedded in the first material.

5. The washer according to claim 4, wherein the second material forms a cylinder extending perpendicular to the two faces of the washer.

6. The washer according to claim 4, further comprising a cylindrical bore passing through the washer from one face to the other, wherein the second material comprises several angular segments surrounding the cylindrical bore.

7. The washer according to claim 4, wherein the second material comprises several stakes extending perpendicular to the two faces of the washer.

8. The washer according to claim 1, wherein the second material forms a lattice embedded in the first material.

9. The washer according to claim 1, wherein the second material is metallic.

10. The washer according to claim 1, wherein the first material is based on polyether ether ketone.

11. The washer according to claim 1, further comprising a bore passing through the washer from one face to the other, the bore running along an axis, the faces, being both perpendicular to the axis.

12. A method of assembling mechanical components using a screw and a washer interposed in the assembly, the washer comprising two opposing faces, the washer being configured to be compressed between its two faces in the assembly, the washer further comprising a first and a second materials both extending from one face to the other, the first material having a lower stiffness than the second material, the method consisting in performing assembly by tightening the assembly until the second material undergoes plastic deformation, the first material remaining in its elastic-deformation domain.
